(19) United States
(12) Patent Application Publication
(10) Pub. No.: US 2024/0054610 A1
(43) Pub. Date: Feb. 15, 2024

(54) IMAGE GENERATION DEVICE, ROBOT CONTROL DEVICE AND COMPUTER PROGRAM

(71) Applicant: FANUC CORPORATION, Yamanashi (JP)

(72) Inventors: Yuuki TAKAHASHI, Yamanashi (JP); Yuta NAMIKI, Yamanashi (JP)

(73) Assignee: FANUC CORPORATION, Yamanashi (JP)

(21) Appl. No.: 18/260,314

(22) PCT Filed: Jan. 7, 2022
(86) PCT No.: PCT/JP2022/000335

§ 371 Date: Jul. 3, 2023

(30) Foreign Application Priority Data
Jan. 12, 2021 (JP) 2021-002903

(51) Int. Cl. G06T 5/50; G06T 5/00; H04N 23/73; H04N 23/741; H04N 23/72; H04N 23/71; B25J 9/20

(52) U.S. Cl. CPC G06T 5/50; G06T 5/009; H04N 23/73; H04N 23/741; H04N 23/72; H04N 23/71; B25J 9/20; G06T 2207/20092; G06T 2207/20221; G06T 2207/30164

(57) ABSTRACT

An image generation device, a robot control device and a computer program are provided which enable widening the range of pixel values in a composite image. This image generation device, for generating a composite image by combining images, is provided with: an image capture number setting unit which sets the number of captured images captured of a subject; an exposure time setting unit which sets the exposure time of the captured images; a brightness range setting unit which sets the brightness range of the subject; an imaging control unit which performs control such that the imaging unit images the subject on the basis of the aforementioned number of captured images and exposure time; and an image combining unit which combines the aforementioned captured images on the basis of the brightness range and generates a composite image.

### TECHNICAL FIELD

The present invention relates to an image generation device, a robot controller, and a computer program.

### BACKGROUND ART

Conventionally, in order to accurately perform work such as handling or machining of a workpiece using a robot, it is necessary to accurately recognize a position where the workpiece is placed and a deviation of the workpiece gripped by the robot. For this reason, in recent years, a visual sensor has been used to visually recognize the position of the workpiece and the deviation of the workpiece (for example, see Patent Document 1).
Patent Document 1: Japanese Unexamined Patent Application, Publication No. 2013-246149

### DISCLOSURE OF THE INVENTION

### Problems to be Solved by the Invention

There is a case where a range of brightness cannot be appropriately represented in one image when an object (for example, a workpiece) is imaged by a visual sensor. For example, when brightness conforms with a bright region in the field of view, a dark region is blackened out and cannot be visually recognized. Conversely, when brightness conforms with a dark region in the field of view, a bright region is whitened out and cannot be visually recognized.

A technique called HDR (High Dynamic Range) composite is known to cope with such problems. This technique generates a composite image with a wide dynamic range, which cannot be obtained from a single image, by combining a plurality of captured images.

A method of generating a composite image from a plurality of captured images is an effective method by reason of adjusting a wide range of brightness values within a specific brightness value while maintaining small brightness features. However, according to such a method, the brightness value may be reduced as a pixel value, and thus an image with little change may be generated.

Machine vision used in robots has processing of recognizing an image by detecting differences in pixel value as features. Reducing the difference in pixel value in such processing leads to lowering a threshold value of the difference in pixel value to be detected. As a result, a problem arises in that the features to be detected increase, which causes an increase in processing time and erroneous detection. Therefore, there is a demand for a technique capable of widening the range in which pixel values exist in a composite image.

### Means for Solving the Problems

An aspect of the present disclosure is directed to an image generation device that generates a composite image in which images are combined, the image generation device including: a number-of-images setting unit that sets a number of images in which an object is to be captured; an exposure time setting unit that sets an exposure time for the images to be captured; a brightness range setting unit that sets a brightness range of the object; an image capturing control unit that controls and causes an image capturing unit to capture images of the object based on the number of images and the exposure time; and an image combining unit that combines the captured images based on the brightness range to thereby generate the composite image.

An aspect of the present disclosure is directed to a robot controller that generates a composite image in which images are combined, the robot controller including: a number-of-images setting unit that sets a number of images in which an object is to be captured; an exposure time setting unit that sets an exposure time for the images to be captured; a brightness range setting unit that sets a brightness range of the object; an image capturing control unit that controls and causes an image capturing unit to capture images of the object based on the number of images and the exposure time; and an image combining unit that combines the captured images based on the brightness range to thereby generate the composite image.

An aspect of the present disclosure is directed to a computer program for causing a computer to execute steps including: a step of setting the number of images in which an object is to be captured; a step of setting an exposure time for the images to be captured; a step of setting a brightness range of the object; a step of controlling and causing an image capturing unit to capture images of the object based on the number of images and the exposure time; and a step of combining the captured images based on the brightness range to generate the composite image.

### Effects of the Invention

According to the present invention, it is possible to widen the range in which the pixel values exist in the composite image.

### BRIEF DESCRIPTION OF THE DRAWINGS

FIG. 1 is a diagram showing a configuration of a robot system according to the present embodiment;

FIG. 2 is a diagram showing a configuration of the robot controller according to the present embodiment;

FIG. 3 is a graph showing a relationship between brightness and pixel values of a composite image in an image generation device according to the present embodiment;

FIG. 4 is a graph showing an example of setting a brightness range in the image generation device according to the present embodiment;

FIG. 5 is a graph showing another example of setting a brightness range in the image generation device according to the present embodiment;

FIG. 6 is a graph showing an example of setting an exposure time in the image generation device according to the present embodiment;

FIG. 7 is a graph showing an example of setting the number of images to be captured, in the image generation device according to the present embodiment;

FIG. 8 is a flowchart showing a flow of processing of the image generation device according to the present embodiment;

FIG. 9 is a diagram schematically showing an example of an image processing system to which a plurality of visual sensors according to the present embodiment are connected; and

FIG. 10 is a diagram schematically showing an example of an image processing system to which a plurality of image generation devices according to the present embodiment are connected.

### PREFERRED MODE FOR CARRYING OUT THE INVENTION

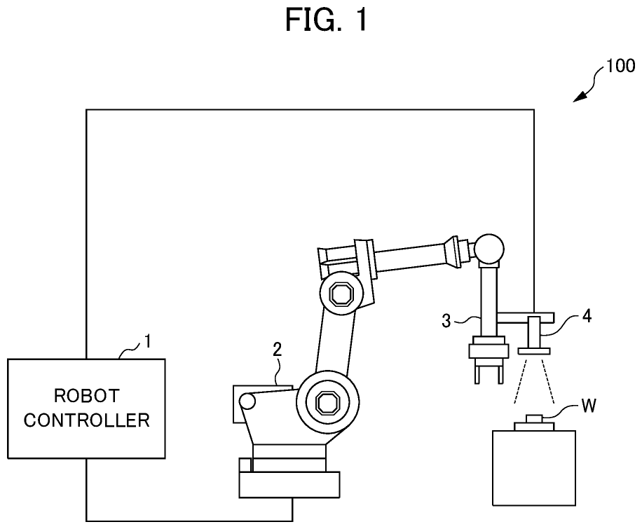

An example of embodiments of the present invention will be described below. FIG. 1 is a diagram showing a configuration of a robot system 100 according to the present embodiment. As shown in FIG. 1, the robot system 100 includes a robot controller 1, a robot 2, an arm 3, and a visual sensor 4.

A hand or a tool is attached to a tip of the arm 3 of the robot 2. The robot 2 performs work such as handling or machining of a workpiece W under control of the robot controller 1. Further, the visual sensor 4 is attached to the tip of the arm 3 of the robot 2. The visual sensor 4 may not be attached to the robot 2, and may be fixed and installed at a predetermined position, for example.

The visual sensor 4 captures an image of the workpiece W under the control of the robot controller 1. The visual sensor 4 may be a two-dimensional camera having an image capturing element configured by a CCD (Charge Coupled Device) image sensor and an optical system including lenses.

The robot controller 1 executes a robot program for the robot 2 to control a motion of the robot 2. At this time, the robot controller 1 compensates the motion of the robot 2 such that the robot 2 performs predetermined work with respect to the position of the workpiece W using an image captured by the visual sensor 4.

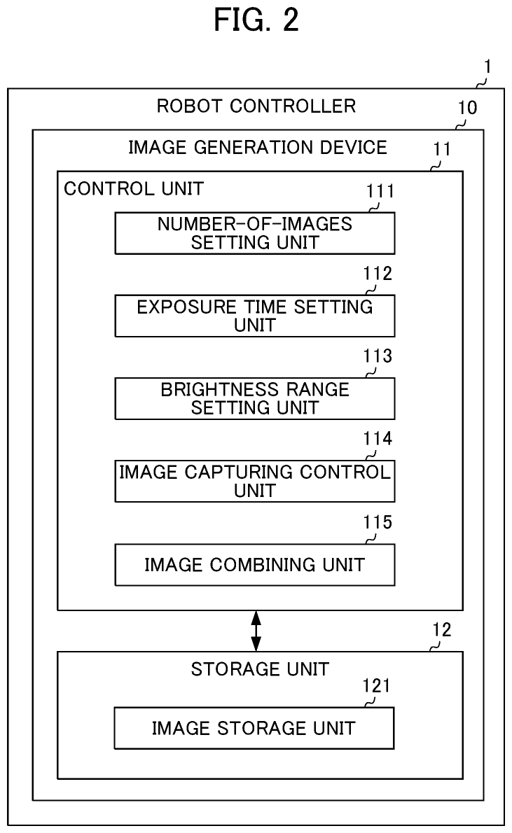

FIG. 2 is a diagram showing a configuration of the robot controller 1 according to the present embodiment. The robot controller 1 includes an image generation device 10. Although the robot controller 1 has a general configuration for controlling the robot 2, the general configuration will not be described for simplification of description. The image generation device 10 is a device for processing the captured image captured by the visual sensor 4 and generating a composite image. The robot controller 1 compensates the motion of the robot 2 such that the robot 2 performs predetermined work with respect to the position of the workpiece W using the composite image generated by the image generation device 10. The image generation device 10 includes a control unit 11 and a storage unit 12.

The control unit 11 is a processor such as a CPU (Central Processing Unit), and implements various functions by executing programs stored in the storage unit 12.

The control unit 11 includes a number-of-images setting unit 111, an exposure time setting unit 112, a brightness range setting unit 113, am image capturing control unit 114, and an image combining unit 115.

The storage unit 12 is a storage device such as a ROM (Read Only Memory) for storing an OS (Operating System) or application programs, a RAM (Random Access Memory), or a hard disk drive and SSD (Solid State Drive) that store various other information. The storage unit 12 stores various information, for example, robot programs. In addition, the storage unit 12 includes an image storage unit 121 that stores captured images.

The number-of-images setting unit 111 sets the number of images of an object (for example, a workpiece W) captured by the visual sensor 4. Specifically, the number-of-images setting unit 111 sets the number of images to be captured, based on a brightness range of the object.

The exposure time setting unit 112 sets an exposure time of the image captured by the visual sensor 4. Specifically, the exposure time setting unit 112 sets the exposure time based on the brightness range of the object.

The brightness range setting unit 113 sets a brightness range of the object. Here, the brightness range may be set by a user's input operation, for example. Further, the brightness range setting unit 113 may set the brightness range of the object based on image information captured by the visual sensor 4. In addition, the brightness range setting unit 113 may set the brightness range of the object based on the image information of the object captured by the visual sensor 4. Here, examples of the image information include distribution of brightness values estimated from the captured image captured by the visual sensor 4 and brightness of a target part in the captured image captured by the visual sensor 4.

The image capturing control unit 114 controls and causes the visual sensor 4 to capture images of the object, based on the number of images to be captured that has been set by the number-of-images setting unit 111 and the exposure time set by the exposure time setting unit 112.

The image combining unit 115 combines the captured images based on the brightness range to thereby generate a composite image. In addition, the image combining unit 115 may adjust pixel values of the captured images based on the brightness range. For example, the image combining unit 115 may combine the captured images by setting the minimum value of the brightness range to 1 of the pixel value of the captured image and setting the maximum value of the brightness range to a number obtained by subtracting 1 from the maximum possible value of the pixel value.

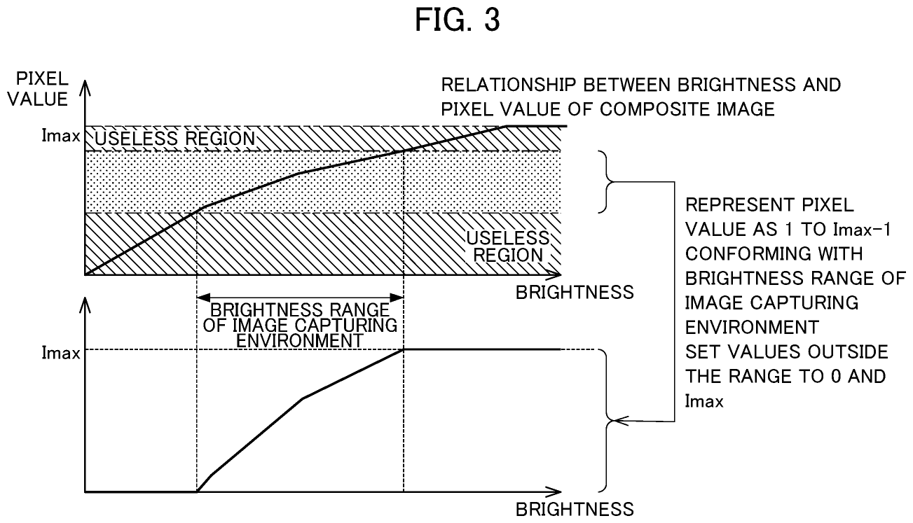

FIG. 3 is a graph showing a relationship between brightness and pixel values of the composite image in the image generation device 10 according to the present embodiment. In the example shown in FIG. 3, the composite image is obtained by combining three captured images with different exposure times. Further, Iₘₐₓ in FIG. 3 indicates the maximum pixel value.

Image features used in a case of detecting the object (for example, the workpiece W) from the composite image include only the brightness range of an effective region. In this case, regions above and below the effective region become useless regions in which no pixel values exist.

Therefore, the image generation device 10 according to the present embodiment represents the pixel values as 1 to Iₘₐₓ-1 conforming with the brightness range of an image capturing environment, for example. In other words, the image generation device 10 sets values outside the range of pixel values to 0 and Iₘₐₓ. Thus, the image generation device 10 can generate a composite image from which useless regions are eliminated, and thus can generate an image with a larger difference in pixels.

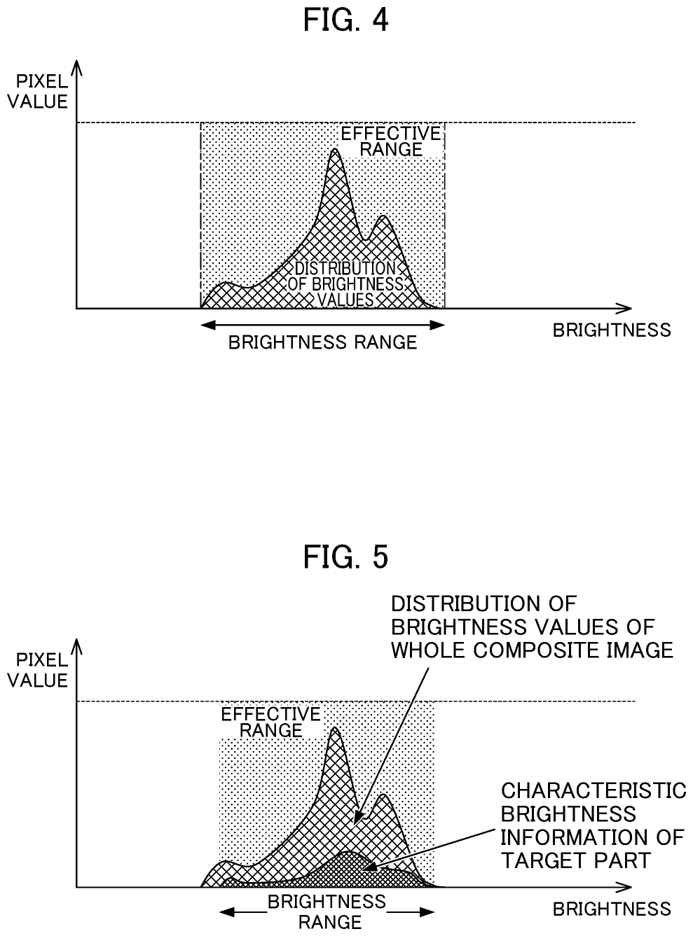

FIG. 4 is a graph showing an example of setting the brightness range in the image generation device 10 according to the present embodiment. As described above, the brightness range setting unit 113 may set the brightness range of the object based on the image information captured by the visual sensor 4.

Specifically, as shown in FIG. 4, the brightness range setting unit 113 estimates, as image information, brightness values from the captured image captured by the visual sensor 4 and draws a distribution of the estimated brightness values. Then, the brightness range setting unit 113 determines and sets the brightness range from the distribution of the brightness values drawn as shown in FIG. 4.

Here, the relationship between brightness and pixel values is described by Formula (1) as follows.

I=C·L·t Formula (1)

Here, I indicates a pixel value, C indicates an arbitrary constant, L indicates brightness, and t indicates an exposure time. Then, a formula for calculating brightness is obtained as follows from the above formula.

L=I/(Ct) Formula (2)

By changing the exposure time t and generating a captured image by the visual sensor 4 in Formula (2), the brightness range setting unit 113 can obtain a distribution of the brightness L in the captured image.

FIG. 5 is a graph showing another example of setting the brightness range in the image generation device 10 according to the present embodiment. As described above, the brightness range setting unit 113 sets the brightness range of the object based on the image information of the object captured by the visual sensor 4.

Specifically, the brightness range setting unit 113 may set, as image information of the object, a brightness range of the object based on brightness of a target part (for example, a specific part in the captured image, or a specific range in the captured image) in the captured image captured by the visual sensor 4.

For example, in the example shown in FIG. 5, the brightness range setting unit 113 sets, as the image information of the object, the brightness range of the object based on characteristic brightness information of the target part in the captured image. In the example shown in FIG. 5, the brightness range to be set is a range narrower than the distribution of brightness values of the whole composite image.

Instead of the examples shown in FIGS. 4 and 5 described above, the brightness range setting unit 113 may set the brightness range of the object based on a brightness range of the image capturing environment acquired using another brightness measuring device or the like.

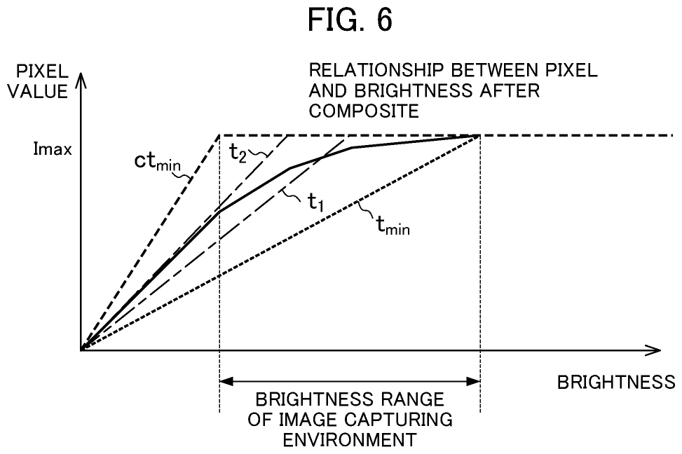

FIG. 6 is a graph showing an example of setting an exposure time in the image generation device 10 according to the present embodiment. As described above, the exposure time setting unit 112 sets the exposure time based on the brightness range. Specifically, when the maximum and minimum values of the brightness are known, the exposure time setting unit 112 may determine and set the exposure time of the image to be captured, as follows.
(1) Determine a minimum exposure time tₘᵢₙ for obtaining the maximum value of the brightness.
(2) Determine a maximum exposure time tₘₐₓ corresponding to the minimum value of the brightness.
(3) Determine a combination of exposure times from the maximum exposure time, the minimum exposure time, and the number of images to be captured.

The combination of exposure times for multiple exposure can use the following method, where a is an arbitrary constant.

tᵢ=T/aⁱ(i=0,1,2, . . . ,n−1) Formula (3)

Here, a indicates a constant that determines the amount of change in exposure time, and n indicates the number of images to be captured.
tᵢ indicates an exposure time when an i-th image is captured. The reason for doing so is that human senses perceive physical quantities logarithmically and are approximated thereto.

The exposure time setting unit 112 implements such logarithmic representation between specific types of brightness. In other words, the exposure time setting unit 112 obtains a logarithmic representation only within specific brightness. A method described below indicates an example for realizing a logarithmic representation only within specific brightness.

As described above, the exposure time setting unit 112 can acquire n images between the minimum exposure time tₘᵢₙ and the maximum exposure time tₘₐₓ, thereby obtaining a logarithmic relationship only within a specific brightness range. Combinations of the exposure times in this case are shown as follows.

Based on tₘᵢₙ, the next image is captured at tₘᵢₙ×x, the next image is captured at (tₘᵢₙ×x)×x, and the next image is captured at (tₘᵢₙ×x)×x, in which the images are captured at the time multiplied by x, respectively.

In other words, when n images are captured, tₘₐₓ is tₘᵢₙ×x⁽ⁿ⁻¹⁾. Here, x can be calculated from a relationship between tₘᵢₙ and tₘₐₓ.

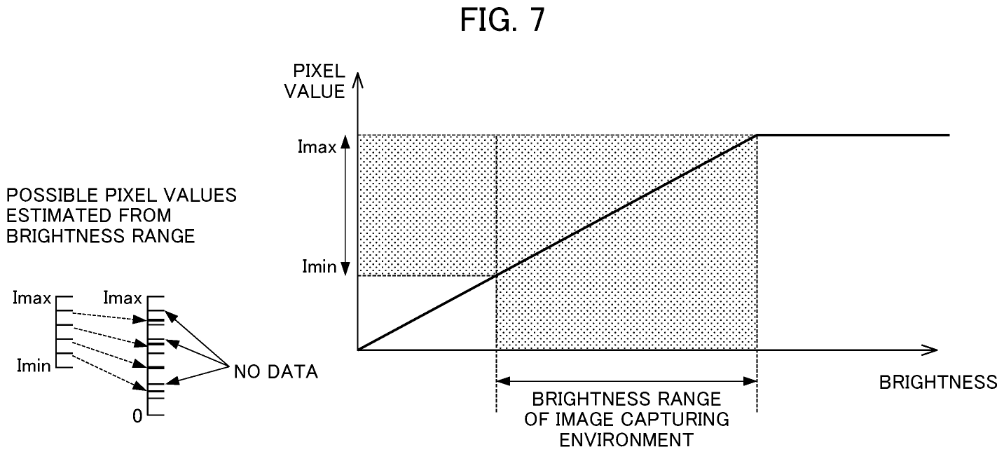

FIG. 7 is a graph showing an example of setting the number of images to be captured, in the image generation device 10 according to the present embodiment. As described above, the number-of-images setting unit 111 sets the number of images to be captured, based on the brightness range of the object. Specifically, as shown in FIG. 7, the number-of-images setting unit 111 estimates possible pixel values from the brightness range.

The range of estimated pixel values is from Iₘₐₓ to Iₘᵢₙ. In a case where the range of the pixel values is represented by 0 to Iₘₐₓ, the pixel values are integers when the range is simply extended, so the values become discrete. In order for the pixel values to be filled up, at least (Iₘₐₓ−Iₘᵢₙ)×n≥Iₘₐₓ should be satisfied. In other words, n=Iₘₐₓ/(Iₘₐₓ−Iₘᵢₙ). The number-of-images setting unit 111 can set n thus obtained as the number of images to be captured.

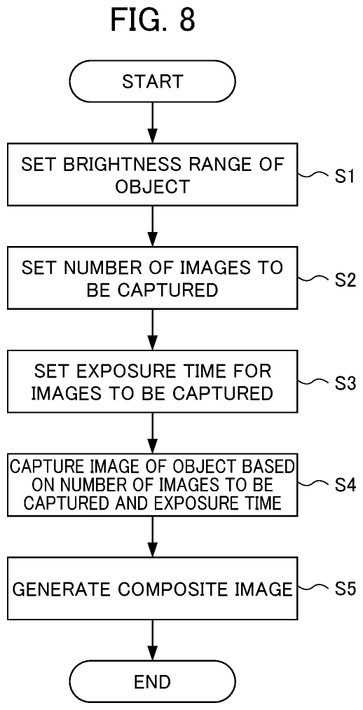

FIG. 8 is a flowchart showing a flow of processing of the image generation device 10 according to the present embodiment. In Step S1, the brightness range setting unit 113 sets a brightness range of the object. In Step S2, the number-of-images setting unit 111 sets the number of images of the object (for example, the workpiece W) to be captured by the visual sensor 4. In Step S3, the exposure time setting unit 112 sets an exposure time of the image captured by the visual sensor 4.

Note that Steps S1 to S3 described above are in random order, and the order of each Step may be changed, or each Step may be executed simultaneously.

In Step S4, the image capturing control unit 114 controls and causes the visual sensor 4 to capture images of the object, based on the number of images to be captured set in Step S2 and the exposure time set in Step S3. Then, the image storage unit 121 stores the captured images. In Step S5, the image combining unit 115 combines the captured images captured in Step S4 based on the brightness range set in Step S1 to thereby generate a composite image.

As described above, according to the present embodiment, the image generation device 10, which generates the composite image in which images are combined, includes: the number-of-images setting unit 111 that sets the number of images in which the object is to be captured; the exposure time setting unit 112 that sets the exposure time for the images to be captured; the brightness range setting unit 113 that sets the brightness range of the object; the image capturing control unit 114 that controls and causes the visual sensor 4 to capture the image of the object based on the number of images to be captured and the exposure time; and the image combining unit 115 that combines the captured images based on the brightness range to generate the composite image.

Thus, the image generation device 10 can eliminate the range where no pixel value exists in the composite image and can represent widely the range where the pixel value exists. Therefore, the image generation device 10 can represent an image with a small pixel difference as an image with a large pixel difference, and can obtain clear features. Thereby, for example, the robot controller 1 can reduce processing time and erroneous detection by using the composite image generated by the image generation device 10.

Further, the brightness range may be set by the user, for example. Thus, the image generation device 10 can suitably obtain the composite image desired by the user.

Further, the brightness range setting unit 113 may set the brightness range based on the image information captured by the visual sensor 4. Thus, the image generation device 10 can appropriately set the brightness range in order to widen the range where the pixel value exists in the composite image.

Further, the brightness range setting unit 113 may set the brightness range based on the image information of the object captured by the visual sensor 4. Thus, the image generation device 10 can appropriately set the brightness range in order to widen the range where the pixel value exists in the composite image.

Further, the exposure time setting unit 112 sets the exposure time based on the brightness range. Thus, the image generation device 10 can appropriately set the exposure time in order to widen the range where the pixel value exists in the composite image.

Further, the number-of-images setting unit 111 sets the number of images to be captured, based on the brightness range. Thus, the image generation device 10 can appropriately set the number of images to be captured in order to widen the range where the pixel value exists in the composite image.

Further, the image combining unit 115 adjusts the pixel value of the captured image based on the brightness range. Thus, the image generation device 10 can generate the composite image in which the range where the pixel value exists is widened, by adjusting the pixel value.

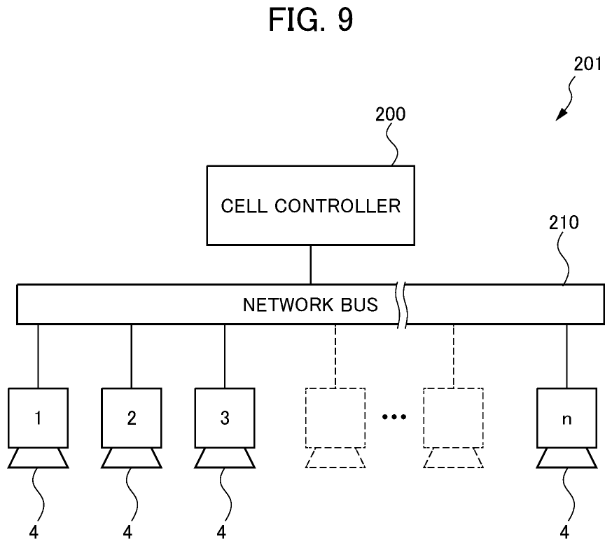

FIG. 9 is a diagram schematically showing an example of an image processing system 201 to which a plurality of visual sensors 4 according to the present embodiment are connected. In FIG. 6, N visual sensors 4 are connected to a cell controller 200 via a network bus 210. The cell controller 200 has the same function as the image generation device 10 described above, and acquires captured images from each of the N visual sensors 4.

In such an image processing system 201 shown in FIG. 9, the cell controller 200 may include, for example, a machine learning device (not shown). The machine learning device acquires a collection of learning data stored in the cell controller 200, and performs supervised learning. In this example, a learning process can also be performed sequentially online.

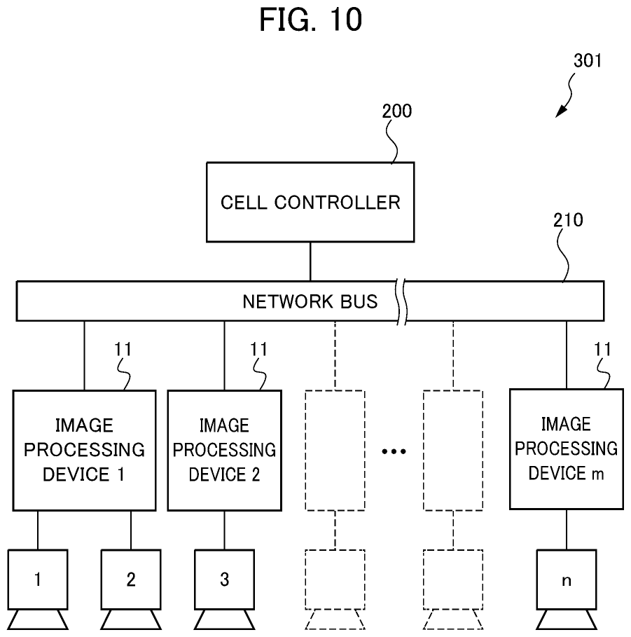

FIG. 10 is a diagram schematically showing an example of an image processing system 301 to which a plurality of image generation devices 10 according to the present embodiment are connected. In FIG. 10, m image generation devices 10 are connected to a cell controller 200 via a network bus 210. One or a plurality of visual sensors 4 are connected to each of the image generation devices 10. The image processing system 301 as a whole includes a total of n visual sensors 4.

In such an image processing system 301 shown in FIG. 10, the cell controller 200 may include, for example, a machine learning device (not shown). The cell controller 200 may store, as learning data set, a collection of learning data sent from the plurality of image generation devices 10, and perform machine learning to construct a learning model. The learning model becomes available for each of the image generation devices 10.

Although the embodiment of the present invention has been described above, the image generation device 10 described above can be implemented by hardware, software, or a combination thereof. Further, the control method performed by the robot controller 1 described above can also be implemented by hardware, software, or a combination thereof. Here, “implemented by software” means implemented by a computer reading and executing a program.

The program may be stored and supplied to a computer using various types of non-transitory computer readable media. The non-transitory computer readable media include various types of tangible storage media. Examples of the non-transitory computer readable media include a magnetic recording medium (for example, a hard disk drive), a magneto-optic recording medium (for example, a magneto-optic disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (Random Access Memory)).

In addition, although the above-described embodiment is a preferred embodiment of the present invention, the scope of the present invention is not limited to only the above-described embodiment, and various modifications can be made without departing from the gist of the present invention.

### EXPLANATION OF REFERENCE NUMERALS

1 robot controller
2 robot
3 arm
4 visual sensor
10 image processing device
11 control unit
12 storage unit
111 number-of-images setting unit
112 exposure time setting unit
113 brightness range setting unit
114 image capturing control unit
115 image combining unit

1. An image generation device that generates a composite image in which images are combined, the image generation device comprising:
a number-of-images setting unit that sets a number of images in which an object is to be captured;
an exposure time setting unit that sets an exposure time for the images to be captured;
a brightness range setting unit that sets a brightness range of the object;
an image capturing control unit that controls and causes an image capturing unit to capture images of the object based on the number of images and the exposure time; and
an image combining unit that combines the captured images based on the brightness range to thereby generate the composite image.

2. The image generation device according to claim 1, wherein the brightness range is set by a user.

3. The image generation device according to claim 1, wherein the brightness range setting unit sets the brightness range based on image information captured by the image capturing unit.

4. The image generation device according to claim 1, wherein the brightness range setting unit sets the brightness range based on image information of the object captured by the image capturing unit.

5. The image generation device according to claim 1, wherein the exposure time setting unit sets the exposure time based on the brightness range.

6. The image generation device according to claim 1, wherein the number-of-images setting unit sets the number of images to be captured, based on the brightness range.

7. The image generation device according to claim 1, wherein the image combining unit adjusts pixel values of each of the captured images based on the brightness range.

8. A robot controller that generates a composite image in which images are combined, the robot controller comprising:
a number-of-images setting unit that sets a number of images in which an object is to be captured;
an exposure time setting unit that sets an exposure time for the images to be captured;
a brightness range setting unit that sets a brightness range of the object;
an image capturing control unit that controls and causes an image capturing unit to capture images of the object based on the number of images and the exposure time; and
an image combining unit that combines the captured images based on the brightness range to thereby generate the composite image.

9. A non-transitory computer-readable storage medium storing a program that is executed by a computer that comprises a processor of an image generation device, the program being executable to cause the computer to perform operations comprising
a step of setting a number of images in which an object is to be captured;
a step of setting an exposure time for the images to be captured;
a step of setting a brightness range of the object;
a step of controlling and causing an image capturing unit to capture images of the object based on the number of images and the exposure time; and
a step of combining the captured images based on the brightness range to thereby generate the composite image.
